(19) United States
(12) Patent Application Publication
(10) Pub. No.: US 2010/0020226 A1
(43) Pub. Date: Jan. 28, 2010

(54) Web camera

(75) Inventor: Chao-Han Chang, Taipei (TW)

Correspondence Address: BACON & THOMAS, PLLC, 625 SLATERS LANE, FOURTH FLOOR, ALEXANDRIA, VA, 22314-1176, US

(73) Assignee: IPEVO CORP., Taipei (TW)

(21) Appl. No.: 12/292,490

(22) Filed: Nov. 20, 2008

(30) Foreign Application Priority Data
Jul. 25, 2008 (TW) 097213354

(51) Int. Cl. H04N 5/232

(52) U.S. Cl. 348/345; 348/222.1; 348/E05.042

(57) ABSTRACT

The web camera of the present invention is used to capture the external images. The web camera of the present invention comprises a circuit control unit, a focal adjustment module, a focus adjustment button, an image capturing module, and a shutter button, wherein the focus adjustment module has an auto-focus mode and a fixed focus mode; the focus adjustment button is electrically connected to the focus adjustment module and the circuit control unit. The focus adjustment button is used to change the mode of the focus module to the auto-focus mode or to the fixed focus mode; the image capturing module is electrically connected to the circuit control unit, which is used to transform the external images into image signals; and the shutter button is electrically connected to the circuit control unit, which is used to send outward the image capturing signals.

### BACKGROUND OF THE INVENTION

1. Field of the Invention

The present invention relates to a web camera, and more particularly, it relates to a web camera capable of changing its mode to the auto-focus mode or the fixed focus mode quickly.

2. Description of the Related Art

Most home cameras adopt the auto-focus mode, and only professional cameras adopt the manual focus mode. The web cameras of prior art are divided into two types: auto-focus cameras and the manual focus cameras. The auto-focus method of the web camera derives from imitation of the home camera; however, manual focus cameras are produced as a cheaper alternative to the auto-focus camera, not as a higher-quality professional camera. The auto-focus web camera is always in the focused state, a condition which definitely has clear advantages. For instance, it is excellent for capturing images from different areas with a hand-held web camera.

However, when the web camera is fixed in a certain position, such as when the user intends to show a portable phone to a far-end user in a certain position away from the web camera (the specific distance between the portable phone and the web camera is 15cm, for example), then the user takes the portable phone out and shows another object in a certain position in front of the camera, where the distance away from the web camera is still about 15 cm. Sometimes the product remains in that certain position, where the distance away from the web camera is 15 cm; sometimes the user changes the product, so the product moves away from the certain position. Therefore, if the web camera is continuously in automatic focuses mode, the result is that the captured picture is often blurred while the web camera is refocusing. Furthermore, if the user intends to show a partial content of a book to the far-end user, the auto-focus function of the web camera is triggered as the user turns to another page, so the far-end user must wait a moment for the web camera to re-focus before the far-end user can read the clear content of the new page.

The web camera is often placed in a fixed position, with the most applicable state is in a defined fixed position, and the user does not intend to refocus (the above instance of turning a page, for example). It is different from the application of the traditional home camera because most home cameras are held by the user while being used. The web camera of the prior art imitates the function of the home camera (adopting the auto-focus mode or the manual focus mode), but such an imitative design cannot satisfy the special applications of the web camera. Therefore, it is desirable to provide a web camera to obviate the aforementioned problems.

### SUMMARY OF THE INVENTION

A main objective of the present invention is to provide a web camera, which can easily change its mode to the auto-focus mode or the fixed focus mode quickly.

In order to achieve the above-mentioned objective, the web camera of the present invention is used to capture external images. The web camera of the present invention comprises a circuit control unit, a focus adjustment module, a focus adjustment button, an image capturing module, and a shutter button, wherein the focus adjustment module has an auto-focus mode and a fixed focus mode, and the focus adjustment button is electrically connected to the focus adjustment module and the circuit control unit. The focus adjustment button is used to change the mode of the focus module to the auto-focus mode or to the fixed focus mode; the image capturing module is electrically connected to the circuit control unit, which is used to transform the external images into image signals, and the shutter button electrically connects to the circuit control unit, which is used to send outward the captured image signals.

According one executable method of the present invention, the mode of the focus adjustment module can be changed between the auto-focus mode and the fixed focus mode when the user presses the focus adjustment button once.

According the another executable method of the present invention, the mode of the focus adjustment module is the auto-focus mode when the user presses the focus adjustment button continuously, and the mode of the focus adjustment module is the fixed focus mode when the user does not press the focus adjustment button.

### BRIEF DESCRIPTION OF THE DRAWINGS

FIG. 1 is a perspective view diagram of the web camera according to the present invention.

FIG. 2 is a structural drawing of the web camera according to the present invention.

### DETAILED DESCRIPTION OF THE PREFERRED EMBODIMENT

The advantages and innovative features of the present invention will become more apparent from the following detailed description when taken in conjunction with the accompanying drawings.

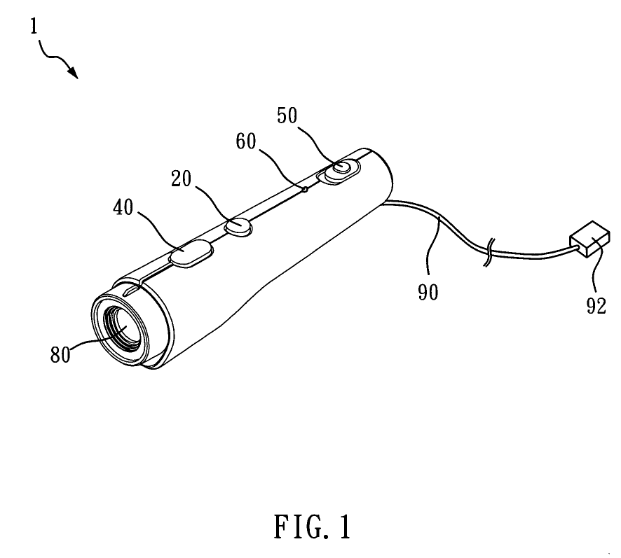

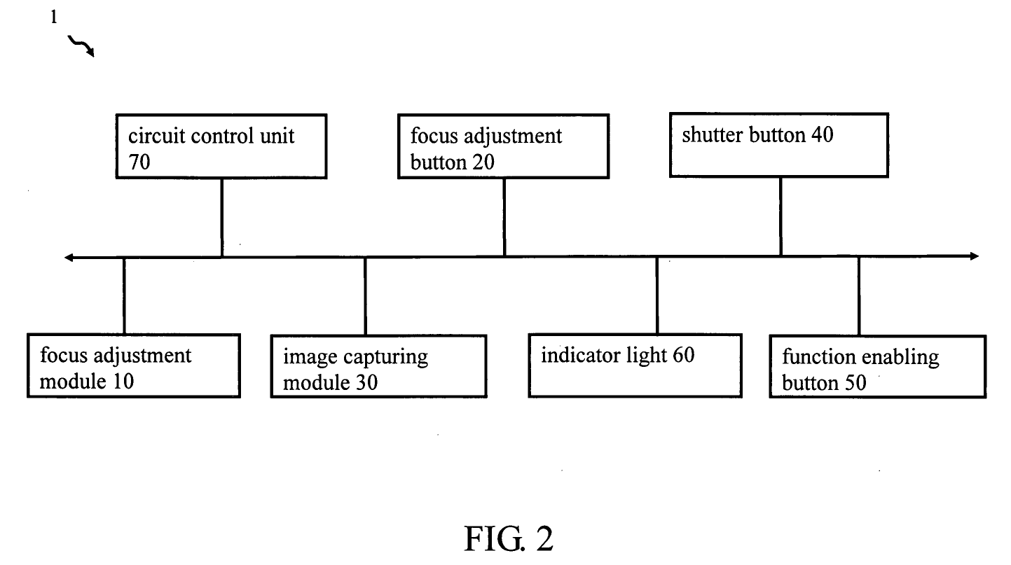

Please refer to FIG. 1 and FIG. 2, which illustrate the preferred embodiment of the present invention. FIG. 1 is a perspective view diagram of the web camera according to the present invention, and FIG. 2 is a structural drawing of the web camera according to the present invention.

The web camera 1 can capture external images for taking static pictures or dynamic video. The web camera 1 mainly comprises a circuit control unit 70, a focus adjustment module 10, a focus adjustment button 20, an image capturing module 30, and a shutter button 40. The circuit control unit 70 is the control center of the web camera 1. For instance, the circuit control unit 70 can consists of a microprocessor or a logic circuit.

The focus adjustment button 20 is electrically connected to the focus adjustment module 10 and the circuit control unit 70. In this preferred embodiment, the web camera 1 is a USB web camera having a USB connector 92, which can electrically connect the web camera 1 to an external computer, and then the signals of the web camera 1 can be transmitted to computer and further processed by the computer.

The focus adjustment module 10 can adjust the focus between the web camera 1 and the captured object such that the images captured by the web camera 1 are clear images. More particularly, the focus adjustment module 10 has an auto-focus mode and a fixed focus mode wherein the auto-focus mode is suitable for being used in situations in which the distance between the web camera 1 and the captured object requires adjustment. In this situation, if the web camera 1 has detected a slight change in the distance between the web camera 1 and the captured object, the focus adjustment module 10 will automatically focus immediately. The fixed focus mode is suitable for being used in situations in which the distance between the web camera 1 and the captured object is fixed. In this situation, the focus of the focus adjustment module 10 is fixed to a specific value. Therefore, the user not only saves time in adjusting the focus but also avoids misadjusting the focus by mistake.

The focus adjustment button 20 can easily change the mode of the focus adjustment module 10 to the auto-focus mode or the fixed focus mode; hence, it has both the convenience of the auto-focus mode and the stability of the fixed focus mode. The following will provide three preferred embodiments about the operating methods relate to the focus adjustment button 20.

(1) When the user presses the focus adjustment button 20 once, the mode of the focus adjustment module 10 can be changed between the auto-focus mode and the fixed focus mode.

More particularly, if the present mode of the focus adjustment module 10 is the auto-focus mode, the mode of the focus adjustment module 10 will be changed to the fixed focus mode when the user presses the focus adjustment button 20. If the present mode of the focus adjustment module 10 is the fixed focus mode, the mode of the focus adjustment module 10 will be changed to the auto-focus mode when the user presses the focus adjustment button 20.

When the user presses the focus adjustment button 20 to change the mode to the fixed focus mode, the focus is fixed at the value at which it is set at the moment at which the user presses the focus adjustment button 20.

In this preferred embodiment, the web camera 1 further comprises an indicator light 60. The indicator light 60 is electrically connected to the circuit control unit 70; the indicator light 60 allows the user to discern between the auto-focus mode and the fixed focus mode of the focus adjustment module 10. For instance, the indicator light 60 turns on when the present mode of the focus adjustment module 10 is the fixed focus mode; the indicator light 60 turns off when the present mode of the focus adjustment module 10 is the auto-focus mode.

(2) The mode of the focus adjustment module 10 is the auto-focus mode when the user presses the focus adjustment button 20 continuously, and when the user does not press the focus adjustment button 20, the mode of the focus adjustment module 10 is the fixed focus mode. The focus of the fixed focus mode is fixed at the moment the auto-focus mode changes to the fixed focus mode.

More particularly, when the user presses the focus button 20 continuously, the mode of the focus module 10 is the auto-focus mode. When the user releases the focus adjustment button 20, the mode of the focus module 10 is the fixed focus mode, and its focus is fixed at the focus value current when the user releases the focus adjustment button 20. Therefore, when the user presses the focus adjustment button 20 continuously, the focus is adjusted to an ideal state, and then the user can release the focus adjustment button 20, and the focus is in a fixed value.

(3) When the user presses the focus adjustment button 20 continuously, the mode of the focus adjustment module 10 is the fixed focus mode. When the user does not press the focus adjustment button 20, the mode of the focus adjustment module 10 is the auto-focus mode. The focus of the fixed focus mode is fixed at the moment the auto-focus mode changes to the fixed focus mode.

Because the difference between the present embodiment and the above-mentioned second embodiment is just in the contrary operating definition of the focus adjustment button 20, the description will not be repeated.

Adjustment of the function setting of the focus adjustment button 20, that is, to set which method of focus adjustment button 20 is active for changing the mode of the focus adjustment module 10 to the auto-focus mode or to the fixed focus mode, can be performed with software of the external computer, the internal firmware of the web camera 1, an additional function changing button on the web camera 1, and so on.

The following describes the operating method of the web camera 1. First, the reflected light of the captured object passes through the lens 80, and then it is focused by the focus adjustment module 10 and transformed into serial images that are processed into image signals by the image capturing module 30 (CCD or CMOS and so on), which is electrically connected to the circuit control unit 70. The image signals can be sent to an external computer by a connection wire 90 and a USB connector 92. The image capturing signals are sent to the external computer when the user presses the shutter button 40, which is electrically connected to the circuit control unit 70. When the external computer has captured the image signals, it captures a static image from the image signals when the user presses the shutter button 40 to complete the procedure of capturing an image.

The web camera 1 further comprises the function enabling button 50, which is connected to the circuit control unit 70. The function enabling button 50 has an enabling position and a disabling position. The mode of the focus adjustment module 10 remains the auto-focus mode when the function enabling button 50 is in the disabling position, and when the user presses the focus adjustment button 20, it will not have any effect. The focus adjustment module 10 can be changed to the auto-focus mode or the fixed focus mode only when the function enabling button 50 is in the enabling position.

Although the present invention has been explained in relation to its preferred embodiment, it is to be understood that many other possible modifications and variations can be made without departing from the spirit and scope of the invention as hereinafter claimed.

What is claimed is:

1. A web camera for capturing an external image, the web camera comprising:
a circuit control unit;
a focus adjustment module comprising an auto-focus mode and a fixed focus mode;
a focus adjustment button electrically connected to the focus adjustment module and the circuit control unit, wherein the focus adjustment button is used for changing the mode of the focus adjustment module to the auto-focus mode or the fixed focus mode;
an image capturing module electrically connected to the circuit control unit, for transforming the external image into an image signal; and
a shutter button electrically connected to the circuit control unit, for sending an image capturing signal.

2. The web camera as claimed in claim 1; when the user presses the focus adjustment button once, the mode of the focus adjustment module is changed between the auto-focus mode and the fixed focus mode.

3. The web camera as claimed in claim 1; when the user presses the focus adjustment button continuously, the mode of the focus adjustment module is the auto-focus mode; when the user does not press the focus adjustment button, the mode of the focus adjustment module is the fixed focus mode.

4. The web camera as claimed in claim 3; the focus of the fixed focus mode is fixed at the moment the auto-focus mode changes to the fixed focus mode.

5. The web camera as claimed in claim 1; when the user presses the focus adjustment button continuously, the focus adjustment module is the fixed focus mode; when the user does not press the focus adjustment button, the focus adjustment module is the auto-focus mode.

6. The web camera as claimed in claim 5; the focus of the fixed focus mode is fixed at the moment the auto-focus mode changes to the fixed focus mode.

7. The web camera as claimed in claim 1 further comprising:
an indicator light electrically connected to the circuit control unit, for showing whether the present mode of the focus adjustment module is the auto-focus mode or the fixed focus mode.

8. The web camera as claimed in claim 2 further comprising:
an indicator light electrically connected to the circuit control unit such that when the indicator light is turned on, it shows that the focus adjustment module is the fixed focus mode.

9. The web camera as claimed in claim 1 further comprising:
a function enabling button electrically connected to the circuit control unit, the function enabling button comprising an enabling position and a disabling position; when the function enabling button is in the disabling position, the focus adjustment module is the auto-focus mode continuously.

10. The web camera as claimed in claim 1, wherein the web camera is a USB web camera.
